(19) United States
(12) Patent Application Publication
(10) Pub. No.: US 2006/0136249 A1
(43) Pub. Date: Jun. 22, 2006

(54) Method for recycling used items

(76) Inventors: Lloyd D. Kagan, Coconut Creek, FL (US); Steven B. Kagan, Coral Springs, FL (US)

Correspondence Address: BRINKLEY, MCNERNEY, MORGAN,;SOLOMON & TATUM, LLP, 19TH FLOOR, 200 EAST LAS OLAS BLVD., Fort Lauderdale, FL, 33301, US

(21) Appl. No.: 11/125,660

(22) Filed: May 10, 2005

Related U.S. Application Data
(63) Continuation-in-part of application No. 11/016,486, filed on Dec. 17, 2004.

(51) Int. Cl. G06Q 99/00

(52) U.S. Cl. 705/1

(57) ABSTRACT

A method for recycling used items, such as automotive parts, includes a manufacturer and a network of service centers that are contractually obligated to return used components to a manufacturer in exchange for warranty payment by the manufacturer. The used items are preferably received by the manufacturer without charge from the service centers under the service centers' obligation to return the components to the manufacturer instead of otherwise disposing of them. The manufacturer sells the returned components to a reclamation facility. The reclamation facility extracts reusable elements from the returned components and sells the elements on the open market. The revenue received by the manufacturer from the sale of the returned components to the reclamation facility is recognized as profit to the manufacturer or is used to offset the manufacturer's warranty costs. The method permits the manufacturer to realize previously unrecognized revenue on the processing of recycled goods.

### CROSS-REFERENCE TO RELATED APPLICATIONS

This application is a continuation-in-part of U.S. application Ser. No. 11/016,486 filed Dec. 17, 2004, which application is incorporated herein in its entirety by this reference, and claims the benefit of such application under 35 U.S.C. § 120.

### BACKGROUND OF THE INVENTION

1. Field of the Invention

The present invention relates generally to the recycling of used durable goods and, in particular, to a method for realizing a heretofore unrealized profit from the recycling of defective, worn out or otherwise used items, such as certain automotive parts. However, it is to be understood that the invention is not limited to the recycling of automotive parts, but will have application in any industry in which recycling of used parts and equipment, or portions thereof, is carried out or can be carried out.

2. Current Relevant Art

It is commonplace in various industries, especially the automotive industry, for defective, worn out, and/or otherwise used parts to be recycled for subsequent sale in an appropriate after market. For example, rebuilt parts are generally sold at a price that is significantly lower than the price of new parts supplied by the original equipment manufacturer (“OEM”). Consequently, there is a sizable market for refurbished products due to their reduced cost to the consumer. Alternatively, when a used part is incapable of refurbishment, elements or materials of such parts may be extracted, reclaimed, or otherwise separated from the parts and resold to either an OEM for use in manufacturing new parts or to a supplier or holder of the element or material. For example, catalytic converters typically include platinum group metals, such as platinum, palladium, and rhodium. Portions of the metals are consumed during the life of the catalytic converter, but usable amounts of the metals typically remain after the converter becomes defective. Since the cost of such metals can range from $100 to more than $1,000 per ounce, there is clearly an incentive to melt the converter down to extract the metals from it for purposes of reselling the metals to users of them, such as investors or catalytic converter manufacturers.

The description of the background art as well as the disclosure of the invention herein will be made, for purposes of example only, in the context of the recycling of used automotive equipment. However, it is to be understood that the scope of this invention is intended to encompass any recycling method and/or system in which defective, worn out, and/or otherwise used goods can be recycled.

Presently, defective, worn out, and/or otherwise used automotive parts are acquired by entities that rebuild/refurbish such parts in three primary ways. First, such parts are acquired from entities commonly known as “core suppliers,” which themselves acquire the used parts from service centers, such as auto repair shops or service/parts departments of automotive dealerships, after the parts are removed from a host article, such as an automobile. The core suppliers are independent businesses that rely upon their own particular resources to find and acquire various used parts. It is widely known in the automotive industry that a great deal of defective, worn out, and/or otherwise used parts never get recycled. Instead, such parts are discarded, winding up in land fills, salvage yards, or industrial waste sites. Some automotive manufacturers actually require their franchisees/dealers to permanently disable and/or destroy used parts so that they cannot be recycled.

The second primary way in which used parts are acquired by rebuilders is from automobile manufacturers. Instead of requiring their dealers to permanently disable and/or destroy used parts removed from serviced automobiles, some automobile manufacturers apply a so-called “core charge” to the price of certain new parts ordered by the service centers. Core charges are fees added by the manufacturer to the cost of new parts purchased by auto parts stores or service centers. Each core charge acts as an incentive for an auto parts store or a service center to supply the manufacturer with defective, refurbishable parts. When a used part is returned to the automobile manufacturer, the core charge is refunded by the manufacturer to the parts store or service center. After receiving the used parts from parts stores and service centers, the manufacturers sell the used parts to the rebuilders for refurbishment. Refinding of core charges provides a monetary incentive for parts stores and service centers to provide a continual supply of refurbishable parts to the manufacturer.

The third primary way in which used parts are acquired by rebuilders is through the use of their own core charges. In this case, core charges added by rebuilders/refurbishers to the cost of rebuilt parts purchased by auto parts stores or service centers. When a used part is returned to a rebuilder, the core charge is refunded by the rebuilder to the parts store or service center. Refunding of the rebuilder's core charge provides a monetary incentive for parts stores and service centers to provide a continual supply of refurbishable parts to the rebuilders.

Various other permutations of the core charge concept are practiced throughout the automotive industry and, in some instances, the core charges are even passed on to the consumer as an incentive for the consumer to return the used part to the retailer. Surprisingly, a significant percentage of core charges are never refunded by the rebuilder or the manufacturer because the “cores,” that is, the used parts, are never returned to the retailer, rebuilder or manufacturer. Thus, the use of core charges, while popular, is not an optimal solution to increase recycling of used parts.

It is also common in the automotive industry for auto service centers to remove defective or broken components that are still under an OEM's warranty and return the components to the OEM for failure analysis purposes. In such cases, the OEMs analyze the defective components and attempt to determine the causes of the failures. Once failure analysis is complete, the defective components are simply discarded.

Defective, worn out, and/or otherwise used automotive parts that are not capable of refurbishment are often acquired by reclamation facilities that extract, reclaim, or otherwise separate reusable materials or elements from the parts. Such parts are typically acquired by reclamation facilities through manufacturers or core suppliers, which obtain the parts from service centers in a manner analogous to that described above in connection the acquisition of used parts from manufacturers and/or core suppliers by rebuilders. The manufacturers and core suppliers sell the used parts to the reclamation facilities, which in turn extract the desired materials or elements (e.g., precious metals or other marketable materials) from the parts and resell the extracted elements to various buyers. For example, certain metal reclamation facilities acquire catalytic converters from manufacturers or core suppliers for purposes of separating and reselling the platinum, palladium, and/or rhodium used to fabricate the converters. Such metals are typically extracted by melting down the converter and using conventional metal extraction techniques.

U.S. Pat. No. 6,609,050 B2 discloses a vehicle warranty and repair computer system. The disclosed system includes a dialog box that displays special messages to the service associate. One such message may be an indication that drive shaft or other parts are to be returned to the vehicle's manufacturer after servicing of the vehicle has been performed. However, that message is isolated and not part of a comprehensive recycling system.

U.S. Patent Application Publication No. US 2004/0034566 A1 discloses a system and method for utilizing recycled parts when a vehicle is repaired. The disclosed system includes a used car distribution system in which a registrant (e.g., service center) stores information about the used car in a main server. A dismantler/parts supplier accesses the stored information, purchases the used car based on the stored information, dismantles the car, and stores information on the used car parts in a “recycled parts” database. A rebuilder accesses the recycled parts database, purchases the used parts, rebuilds them and stores data regarding the rebuilt parts in the recycled parts database. A user of the rebuilt parts accesses the recycled parts database and orders the rebuilt parts from the rebuilder.

U.S. Patent Application Publication No. US 2003/0120677 A1 discloses a closed loop asset management system. The disclosed system requires defective parts to be returned to a logical asset management network and process depot. The logical asset management network and process depot ships the defective parts to a warehouse, which in turn repairs the parts or sends them to an offsite repair facility. The repaired parts are returned to the warehouse, bar coded and replaced in inventory.

Although certain of these references separately disclose the broad concepts of returning defective parts to a vehicle manufacturer and of purchasing defective parts by a rebuilder, the references do not disclose or suggest a comprehensive recycling process involving the vehicle manufacturer.

Therefore, a need exists for a recycling method that provides incentives to manufacturers, service centers, refurbishers, and reclamation facilities to recycle certain defective, broken, worn out, or otherwise used items to the benefit of the environment and to the financial benefit of those involved. Such a method that eliminates or mitigates the need for core suppliers would be a further improvement over the prior art.

### SUMMARY OF THE INVENTION

Therefore, it is one object of the present invention to provide a method for recycling defective, worn out, or otherwise used goods in which a service or repair center (e.g., an automotive dealership or an auto repair shop) returns a used item to a manufacturer pursuant to a contractual arrangement with the manufacturer in exchange for consideration by the manufacturer (e.g., warranty payment for acquisition and installation of a replacement component), and the manufacturer provides the used component to a refurbisher/rebuilder or a reclamation facility in exchange for consideration (e.g., money) from the refurbisher/rebuilder or reclamation facility. As used herein, the term reclamation facility refers to any entity that extracts, reclaims, or otherwise separates reusable materials, components, subcomponents, or elements (collectively, “elements”) from a non-refurbishable used part.

It is also an object of this invention to provide a means for manufacturers, such as OEMs, to recognize profit from the recycling of the OEMs' defective, worn out, or otherwise used components.

It is further an object of this invention to provide a method by which service/repair centers are incentivized or required to recycle defective, worn out, or otherwise used goods in lieu of discarding such items.

It is a still further object of this invention to provide a method whereby defective, worn out, or otherwise used goods are recycled instead of being discarded.

To solve the problems described above and to realize the objects of this invention, the present invention is comprised of a method and system for recycling defective, worn out, or otherwise used components, such as, by way of example, automotive parts, wherein a network of service/repair centers (“service centers”) (e.g., service/parts departments of automotive dealerships or independent automotive repair facilities) are contractually obligated to return defective, worn out or otherwise used components to a manufacturer in exchange for consideration (e.g., warranty payment by the manufacturer). The manufacturer in turn sells the returned components to a refurbisher or reclamation facility, as applicable. The refurbisher refurbishes or rebuilds the components, and sells them on the open market. The reclamation facility extracts or separates reusable elements from the returned items and sells the reusable elements on the open market. The revenue received by the manufacturer from the sale of the returned components to the refurbisher or the reclamation facility is recognized as profit by the manufacturer or is used to offset the manufacturer's warranty costs since the returned items were preferably received without independent cost from the service repair center. In a preferred embodiment, in order to receive warranty payment from the manufacturer for replacing a warranted, refurbishable or recyclable item, the service centers are contractually obligated to return the warranted item to the manufacturer, at no cost or a nominal cost to the manufacturer, instead of otherwise disposing of the item. In another embodiment, in order to receive warranty payment from the manufacturer for replacing or otherwise servicing any particular warranted item, the service centers are contractually obligated to return to the manufacturer all warranted or non-warranted, refurbishable or recyclable items originally distributed by the manufacturer which are received from customers or are removed during servicing of host articles distributed by the manufacturer, instead of otherwise disposing of the items.

In yet another embodiment, the chain of custody of the defective, worn out, or otherwise used parts (hereinafter sometimes collectively referred to as “recyclable parts”) need not pass through the manufacturer. Rather, the recyclable parts may be acquired directly by the rebuilder/refurbisher or reclamation facility and, in connection therewith, the rebuilder/refurbisher or reclamation facility pays the manufacturer consideration for the parts, whereupon the recyclable parts are rebuilt/refurbished (hereinafter “recycled parts”) or elements thereof are separated (hereinafter “reclaimed elements”) and placed back into the market as used parts or materials. Thereafter, there may or may not be a core charge associated with the recycled parts. Still further, various middlemen may be involved in transitioning the used parts from the service center to the manufacturer, the refurbisher, or the reclamation facility.

### BRIEF DESCRIPTION OF THE DRAWINGS

FIG. 1 is a block diagram of a system for recycling used items in accordance with a preferred embodiment and an alternative embodiment of the present invention in which the used items are refurbished.

FIG. 2 is a flow diagram of steps executed by a manufacturer to recycle used items in accordance with a preferred embodiment of the present invention.

FIG. 3 is a flow diagram of steps executed by a service center to recycle used items in accordance with a preferred embodiment of the present invention.

FIG. 4 is a flow diagram of steps executed by a refurbisher to recycle used items in accordance with a preferred embodiment of the present invention.

FIG. 5 is a flow diagram of steps executed by a manufacturer to recycle used items in accordance with an alternative embodiment of the present invention.

FIG. 6 is a flow diagram of steps executed by a service center to recycle used items in accordance with an alternative embodiment of the present invention.

FIG. 7 is a flow diagram of steps executed by a refurbisher to recycle used items in accordance with an alternative embodiment of the present invention.

FIG. 8 is a block diagram of a system for recycling used items in accordance with third and fourth embodiments of the present invention in which recyclable elements of the used items are reclaimed.

FIG. 9 is a flow diagram of steps executed by a manufacturer to recycle used items in accordance with the third embodiment of the present invention.

FIG. 10 is a flow diagram of steps executed by a reclamation facility to recycle used items in accordance with the third embodiment of the present invention.

FIG. 11 is a flow diagram of steps executed by a manufacturer to recycle used items in accordance with the fourth embodiment of the present invention.

FIG. 12 is a flow diagram of steps executed by a service center to recycle used items in accordance with the fourth embodiment of the present invention.

FIG. 13 is a flow diagram of steps executed by a reclamation facility to recycle used items in accordance with the fourth embodiment of the present invention.

FIG. 14 is a flow diagram of steps executed by an intermediary entity to recycle used items in accordance with a fifth embodiment of the present invention in which recyclable elements of the used items are reclaimed.

### DETAILED DESCRIPTION OF A PREFERRED EMBODIMENT

Generally, the present invention encompasses a method and system for recycling used items that requires the items to be returned to the manufacturer or other source of them prior to refurbishment of the items or reclamation of reusable elements from the items. In accordance with one embodiment of the present invention, a used item extracted from a durable good, such as an automobile, is returned to the manufacturer of the good (e.g., the automobile OEM), either directly or indirectly (e.g., via one or more intermediary entities), in exchange for some consideration, such as a warranty payment. The manufacturer then provides the used item to a refurbisher, reclamation facility, or an intermediary entity (e.g., a core supplier) in exchange for consideration, such as monetary compensation. The money received by the manufacturer is profit to the manufacturer or may be alternatively used to offset warranty costs.

The refurbisher rebuilds, refurbishes or otherwise fixes the used item and then resells it to a bona fide purchaser for value, such as a service center, salvage yard, or retail store. If the used item is not refurbishable, but contains reusable elements, the reclamation facility removes, separates or otherwise extracts any usable elements from the used item (e.g., precious metals), and resells the extracted elements to a bona fide purchaser for value, such as a manufacturer of the item from which the elements were removed. If the manufacturer provides the used part to an intermediary entity, the intermediary entity sells or otherwise distributes the part to the refurbisher or reclamation facility, as applicable.

The article or durable good manufacturer preferably insures that it receives every refurbishable or recyclable item, or at least every refurbishable or recyclable item for which there is a resale market, removed from goods or articles manufactured by it by contractually requiring service centers to supply such items to the manufacturer in order to receive warranty payment for parts and labor expended in removing the used item from the article and replacing the used item with a replacement (new or refurbished) item. Alternatively, if the manufacturer does not want to be directly involved in the actual flow of the used items, the service center may provide the used item directly or indirectly (e.g., via one or more core suppliers or other intermediary entities) to the refurbisher or reclamation facility, and the manufacturer may require the service center, the refurbisher, and/or the reclamation facility to pay the manufacturer a mutually agreed upon or predetermined amount for each recyclable item sent from the service center or received by the refurbisher or reclamation facility.

By recycling used items in this manner, the present invention provides a system in which recycling is highly encouraged or required by the manufacturer in order for a service center to receive warranty payment. In addition, the manufacturer receives payment or other consideration for the used item in order to increase the manufacturer's profit or offset the manufacturer's warranty costs.

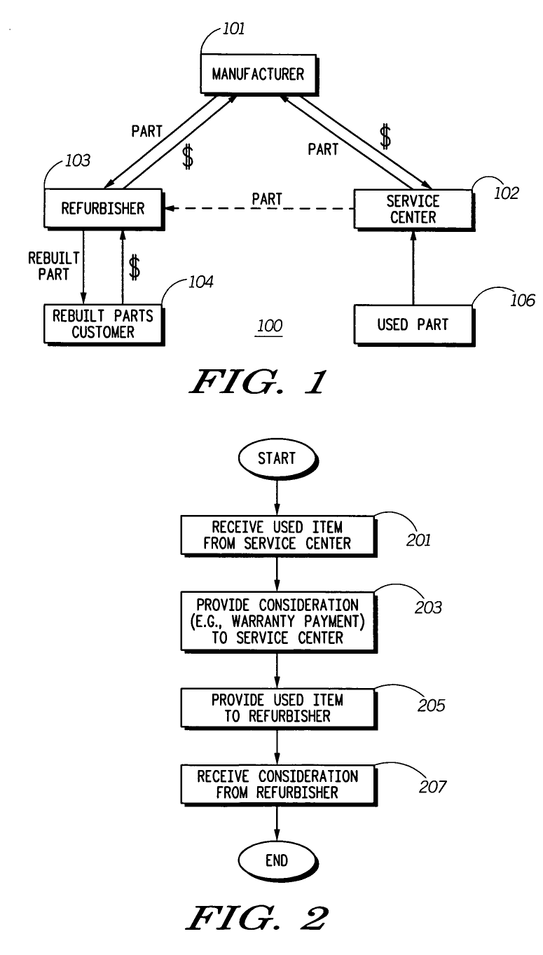

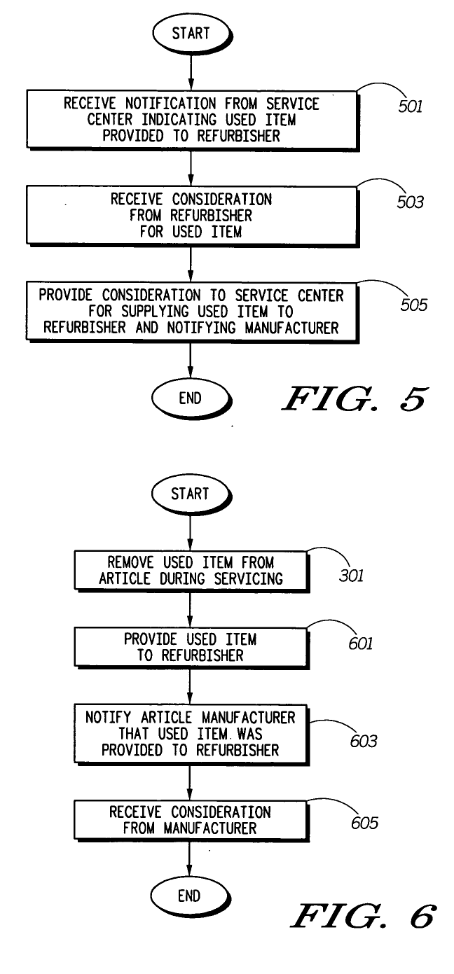

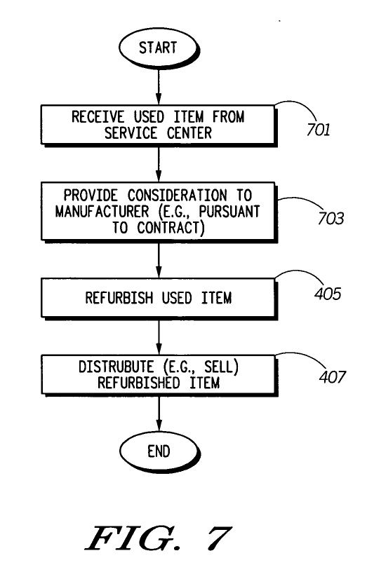

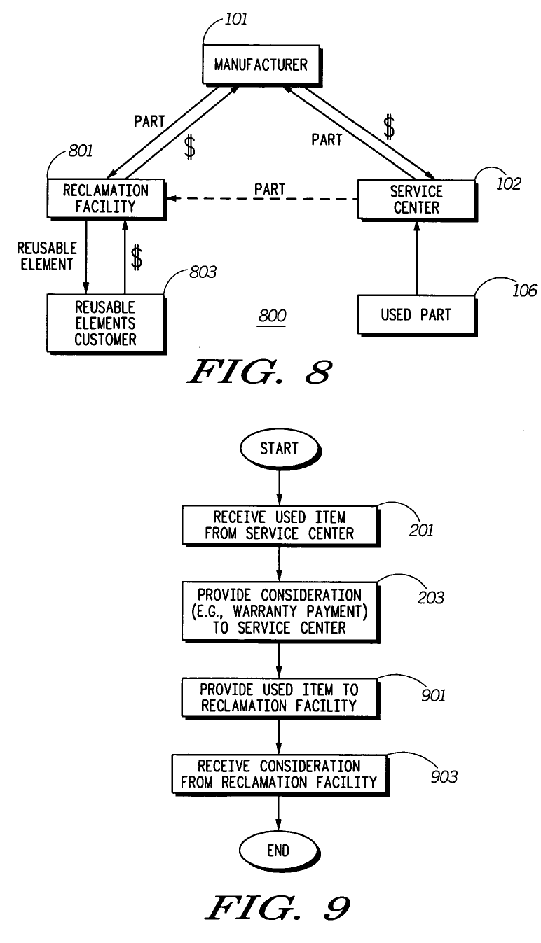

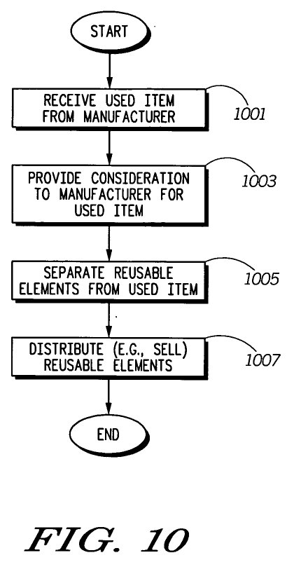

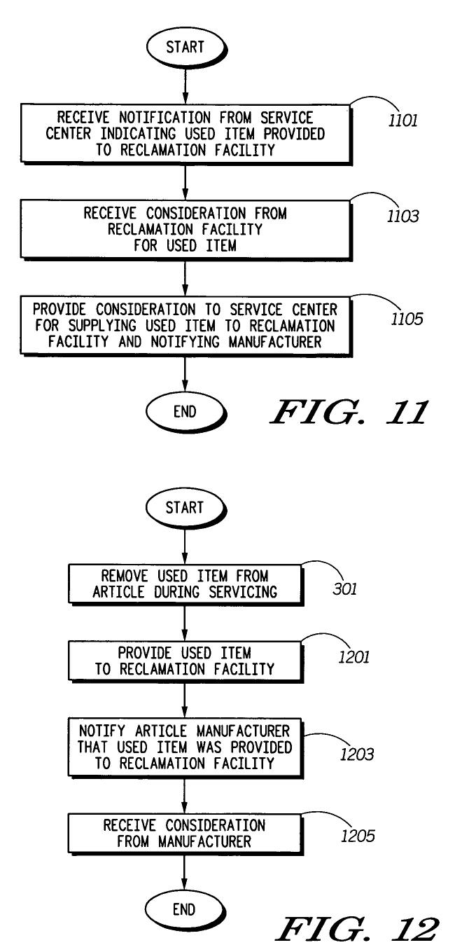

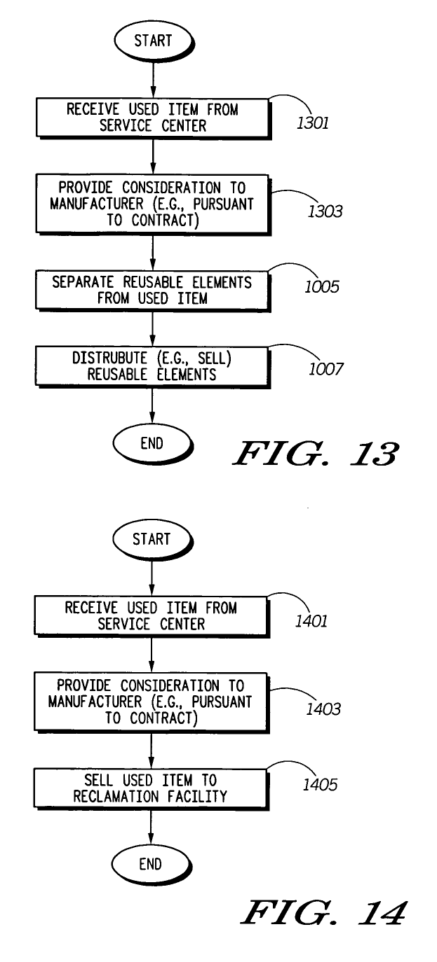

The present invention can be more fully understood with reference to FIGS. 1-14, in which like reference numerals designate like items. FIG. 1 is a block diagram of a system 100 for recycling used items in accordance with preferred and first alternative embodiments of the present invention. The system 100 includes a manufacturer 101, a service/repair center 102, a refurbisher 103, and a rebuilt parts customer 104. In accordance with the present invention, the flow of recyclable, used items 106 from the service center 102 to the manufacturer 101 to the refurbisher 103 may be direct or indirect. Therefore, as used herein, the term “manufacturer” 101 means a producer or distributor (e.g., a franchisor) of the original item or part that has become used, an OEM or other producer of the article (e.g., automobile, boat, motorcycle, television, computer, and so forth) from which the used item 106 was removed, and/or any entity controlled by, under common control with, controlling, affiliated with, or under contract with the manufacturer 101 through which the manufacturer 101 obtains refurbishable or recyclable, used parts or other items and/or sells or distributes refurbished or recycled items. In addition, the term “service center” 102 means the entity that services or repairs the used item 106 or the article from which the used item 106 is removed, or any entity controlled by, under common control with, controlling, affiliated with, or under contract with the service center 102 through which the service center 102 provides the used item 106 to the manufacturer 101, the refurbisher 103, or, as discussed in more detail below with respect to FIGS. 8-14, a reclamation facility 801 in exchange for consideration (e.g., warranty payment) from the manufacturer 101. Finally, the term “refurbisher” 103 means the entity that refurbishes, rebuilds or repairs the used item 106 or any entity controlled by, under common control with, controlling, affiliated with, or under contract with the refurbisher 103 through which the refurbisher 103 acquires or refurbishes the used item 106, or distributes the refurbished item.

Operation of the recycling system 100 in accordance with a preferred embodiment of the present invention may be more fully understood with reference to FIGS. 1-4. In the preferred embodiment, the service center 102 services an article (not shown), such as a car, truck, boat, recreational vehicle (RV), snowmobile, motorcycle, television, stereo receiver, or any other device that includes recyclable components or parts, and removes (301) a recyclable or refurbishable, used item (e.g., an automotive or other component) from the article. When the article serviced is an automobile, the service center 102 may be an independent automotive repair facility or the service/parts department of an automotive dealership. When the entire article is refurbishable or recyclable, the “item” referred to above may be the entire article for purposes of the present invention, and removal (301) of the item by the service center 102 may simply comprise receiving the article from a customer.

Preferably, although not necessarily, pursuant to a contractual arrangement with the manufacturer 101 of the article or the item 106, the service center 102 provides (201, 303) the used item 106 to the manufacturer 101 and, in at least partial exchange, receives (203, 305) consideration from the manufacturer 101. When the used part 106 or the article from which the part 106 was removed is still under a warranty offered by the manufacturer 101, the consideration paid by the manufacturer 101 to the service center 102 preferably comprises some or all of the warranty payment necessary to reimburse the service center 102 for its parts and labor costs associated with procuring a replacement part (new or refurbished) and servicing the article (including replacing the defective or worn out item 106 with the replacement part). That is, in the preferred embodiment, no formal compensation is provided for the used item 106 itself, rather warranty payment for the service center's servicing of the article (e.g., automobile) is conditioned upon the manufacturer's receipt of the used item 106. Thus, pursuant to the present invention, the consideration provided (203) to the service center 102 by the manufacturer 101 is preferably conditioned on the service center's compliance with several obligations, including servicing the article or used item 106 and providing (303) the used item 106 to the manufacturer 101.

Payment by the manufacturer 101 may be immediate or may be delayed by a certain time period as set forth in the contractual arrangement between the manufacturer 101 and the service center 102. Alternatively, the consideration provided by the manufacturer 101 may be in any form as mutually agreed upon by the manufacturer 101 and the service center 102, although monetary compensation of the warranty payment is the preferred form of consideration provided to the service center 102.

In an alternative embodiment, the contractual arrangement between the manufacturer 101 and the service center 102 may provide that consideration will be provided to the service center 102 only if the removed, used item 106 is replaced with a replacement item (e.g., warranty service has been completed) and the used item 106 is returned to the manufacturer 101 at nominal or no cost to the manufacturer 101, thereby eliminating the service center's ability to mark-up or apply a core charge to the used item 106. Further, the contractual arrangement between the manufacturer 101 and the service center 102 may additionally or alternatively provide that consideration will be provided to the service center 102 only if the removed, used item 106 is replaced with a replacement item and all used items removed from articles manufactured by the manufacturer 101 are returned to the manufacturer 101 at nominal or no cost to the manufacturer 101 (e.g., during a predetermined time period, such as a month or a calendar quarter). By conditioning payment of consideration on receipt of the used item 106, the manufacturer 101 provides a great incentive to the service center 102 to supply the manufacturer 101 with the used items 106.

After receiving (201) the used item 106 from the service center 102, the manufacturer 101 preferably sells or otherwise provides (205, 401) the used item 106 to the refurbisher 103. In exchange for receiving (401) the used item 106 from the manufacturer 101, the refurbisher 103 provides (207, 403) consideration to the manufacturer 101 in exchange for the used item 106. The consideration can be in any form, but preferably comprises monetary compensation. In addition, the consideration may be paid immediately or at a later time pursuant to a contractual arrangement between the manufacturer 101 and the refurbisher 103.

After receiving (401) the used item 106 from the manufacturer 101, the refurbisher 103 refurbishes, rebuilds, or otherwise repairs (405) the used item 106 and sells or otherwise distributes (407) the refurbished item to an appropriate customer 104 (e.g., a service center 102). Once the refurbished item is in the hands of the new owner, the used item 106 has completed its recycling process.

Operation of the recycling system 100 in accordance with an alternative embodiment may be more fully understood with reference to FIGS. 1 and 5-7. In the alternative embodiment, instead of supplying the used item 106 to the manufacturer 101 after removing (301) the item 106 from the article, the service center 102 provides (601, 701) the used item 106 to the refurbisher 103 (as indicated by the dashed “PART” line in FIG. 1) and notifies (501, 603) the manufacturer 101. The notification may be in any form and may be made after each conveyance or in regular intervals (e.g., monthly or quarterly). For example, when notifications are made in intervals, each notification preferably indicates all used items 106 that were removed from articles originally manufactured or supplied by the manufacturer 101 and that were provided to refurbishers 103. Some time after receiving (501) the notification from the service center 102, the manufacturer 101 provides (505, 605) consideration to the service center 102 in connection with its completion of warranty services, supply of the used item 106 to the refurbisher 103, and notification to the manufacturer 101. The consideration preferably comprises payment for parts and labor associated with the service center's completion of the warranty service (e.g., procurement and installation of a replacement item), but may include other benefits as well, such as, by way of example only, discounts on new articles (e.g., where the service center 102 is the service department of an automobile dealership that purchases new automobiles from the manufacturer 101) or manufacturer-subsidized advertising.

After receiving (701) the used item 106 from the service center 102, the refurbisher 103 provides (503, 703) consideration to the manufacturer 101 pursuant to a contractual arrangement between the refurbisher 103 and either the manufacturer 101 or the service center 102. The refurbisher 103 then refurbishes, rebuilds, or otherwise repairs (405) the used item 106 and sells or otherwise distributes (407) the refurbished item to an appropriate customer 104. In this embodiment, the used item 106 does not flow through the manufacturer 101; however, the manufacturer 101 still receives revenue from the refurbisher 103 for permitting recycling of the used item 106.

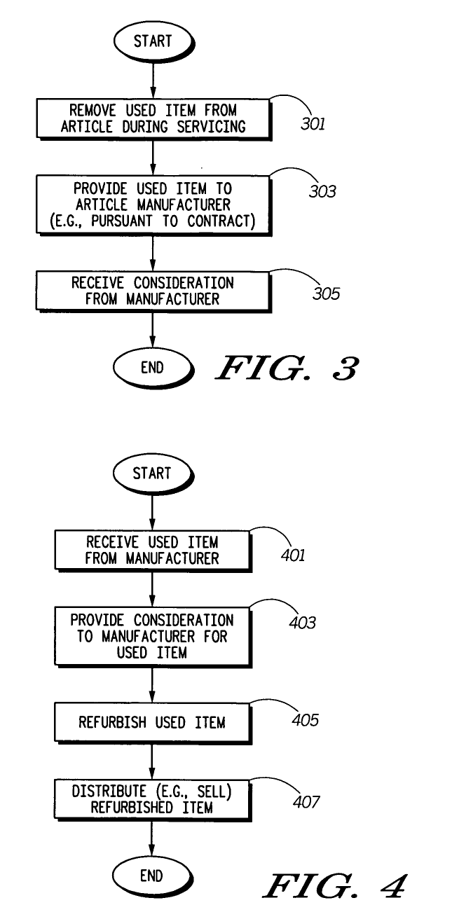

Operation of a recycling system 800 in accordance with a third embodiment of the present invention may be more fully understood with reference to FIGS. 3 and 8-10. The system 800 includes the manufacturer 101, the service/repair center 102, a reclamation facility 801, and a reusable elements customer 803. In accordance with this embodiment of the present invention, the flow of recyclable, used items 106 from the service center 102 to the manufacturer 101 to the reclamation facility 801 may be direct or indirect. Therefore, in connection with the embodiments disclosed in connection with FIGS. 8-14, the terms “manufacturer” 101 and “service center” 102 shall have the meanings ascribed to them above and the term “reclamation facility” 801 shall mean the entity that extracts, reclaims, or otherwise separates reusable materials, components, subcomponents, or elements (collectively, “elements”) from a non-refurbishable used part or any entity controlled by, under common control with, controlling, affiliated with, or under contract with the reclamation facility 801 through which the reclamation facility 801 acquires or separates reusable elements from the used item 106, or distributes the reusable elements.

In this embodiment, the service center 102 performs the same functions as it performs in connection with the preferred embodiment disclosed above with respect to FIGS. 1-4. However, the functions of the manufacturer 101 are slightly different than the operations of the manufacturer 101 discussed above due to the introduction of the reclamation facility 801 in this embodiment.

As discussed above, the service center 102 provides (201, 303) the used item 106 to the manufacturer 101 and, in at least partial exchange, receives (203, 305) consideration from the manufacturer 101. For example, when the used part 106 or the article from which the part 106 was removed is still under a warranty offered by the manufacturer 101, the consideration paid (203) by the manufacturer 101 to the service center 102 preferably comprises some or all of the warranty payment necessary to reimburse the service center 102 for its parts and labor costs associated with procuring a replacement part and servicing the article (including replacing the defective or worn out item 106 with a replacement part).

Payment by the manufacturer 101 may be in any form and may be immediate or delayed by a certain time period as set forth in a contractual arrangement between the manufacturer 101 and the service center 102. Alternatively, other contractual restrictions may be placed on the manufacturer's payment as discussed above in connection with the preferred embodiment of the present invention.

After receiving (201) the used item 106 from the service center 102, the manufacturer 101 preferably sells or otherwise provides (901, 1001) the used item 106 to the reclamation facility 801. In exchange for receiving (1001) the used item 106 from the manufacturer 101, the reclamation facility 801 provides (903, 1003) consideration to the manufacturer 101 for the used item 106. The consideration can be in any form, but preferably comprises monetary compensation. In addition, the consideration may be paid immediately or at a later time pursuant to a contractual arrangement between the manufacturer 101 and the reclamation facility 801.

After receiving (1001) the used item 106 from the manufacturer 101, the reclamation facility 801 extracts, reclaims or otherwise separates (1005) reusable elements from the used item 106 and sells or otherwise distributes (1007) the reusable elements to an appropriate customer 803 (e.g., a manufacturer of the item 106 from which the elements were extracted or any other entity (e.g., an investor if the extracted elements are susceptible to appreciation)). For example, when the used item 106 is catalytic converter of an automobile, the reclamation facility 801 may extract or separate any remaining reusable metals, such as platinum, palladium and/or rhodium, from the converter in accordance with known metal extraction techniques and resell the extracted metals to a catalytic converter manufacturer or an investor in such metals. Once the reusable elements are in the hands of the new owner(s), the used item 106 has completed its recycling process pursuant to this embodiment of the invention.

Operation of the recycling system 800 of FIG. 8 in accordance with a fourth embodiment of the present invention may be more fully understood with reference to FIGS. 8 and 11-13. In this fourth embodiment, instead of supplying the used item 106 to the manufacturer 101 after removing (301) the item 106 from the article, the service center 102 provides (1201, 1301) the used item 106 to the reclamation facility 801 (as indicated by the dashed “PART” line in FIG. 8) and notifies (1101, 1203) the manufacturer 101. The notification may be in any form and may be made after each conveyance or in regular intervals (e.g., monthly or quarterly). For example, when notifications are made in intervals, each notification preferably indicates all used items 106 that were removed from articles originally manufactured or supplied by the manufacturer 101 and that were provided to reclamation facilities 801 during the particular interval. Some time after receiving the notification from the service center 102, the manufacturer 101 provides (1105, 1205) consideration to the service center 102 in connection with its completion of warranty services, supply of the used item 106 to the reclamation facility 801, and notification to the manufacturer 101. The consideration preferably comprises payment for parts and labor associated with the service center's completion of the warranty service (e.g., procurement and installation of a replacement item), but may include other benefits as well, such as, by way of example only, discounts on new articles (e.g., where the service center 102 is the service department of an automobile dealership that purchases new automobiles from the manufacturer 101) or manufacturer-subsidized advertising.

After receiving (1301) the used item 106 from the service center 102, the reclamation facility 801 provides (1103, 1303) consideration to the manufacturer 101 pursuant to a contractual arrangement between the reclamation facility 801 and either the manufacturer 101 or the service center 102. The reclamation facility 801 then extracts, reclaims or otherwise separates (1005) the reusable elements from the used item 106 and sells or otherwise distributes (1007) the reusable elements to an appropriate customer 803. In this embodiment, the used item 106 does not flow through the manufacturer 101; however, the manufacturer 101 still receives revenue from the reclamation facility 801 for permitting recycling of the used item 106.

In yet another embodiment of the present invention, as illustrated in flow diagram form in FIG. 14, the service center 102 may provide (1401) the used item 106 to an intermediary entity (not shown), such as a core supplier or other entity. After receiving (1401) the used item 106 from the service center 102, the intermediary entity provides (1403) consideration to the manufacturer 101 of the article from which the used item 106 was removed by the service center 102 (e.g., pursuant to a contractual arrangement between the intermediary entity and either the manufacturer 101 or the service center 102). The consideration may be provided immediately (e.g., within a few business days) or at regular intervals (e.g., monthly or quarterly). The intermediary entity sells (1405) the used item 106 to the reclamation facility 801 to facilitate the recycling process.

The present invention encompasses a method for recycling used items in which, in a preferred embodiment, a manufacturer of an article from which a recyclable, used item is removed receives the used item pursuant to a contractual obligation of a service center that removed the item and serves as the middleman or core supplier in the recycling process. Alternatively, the manufacturer receives payment from a refurbisher or reclamation facility after the service center that removed the used item provides such item to the refurbisher or reclamation facility and notifies the manufacturer. With this invention, recycling of used items is increased because all key parties in the recycling process flow—the manufacturer, the service center, the refurbisher, and/or the reclamation facility—receive adequate incentives to justify and encourage recycling of used items. In contrast to prior art systems, no independent core suppliers are necessary because the manufacturer directly or indirectly controls the flow of the used item in the recycling process. In addition, in accordance with the present invention, the manufacturer receives consideration (e.g., revenue) for the used item, which consideration can be used to increase the manufacturer's profits or offset its warranty costs. Such revenue on recycled goods has heretofore gone primarily unrecognized by the manufacturer.

In the foregoing specification, the present invention has been described with reference to specific embodiments. However, one of ordinary skill in the art will appreciate that various modifications and changes may be made without departing from the spirit and scope of the present invention as set forth in the appended claims. For example, consideration may be provided to the manufacturer 101 or to the service center 102 in forms other than monetary compensation. In addition, intermediary entities may provide the actual interfaces between the manufacturer 101, the service center 102, the refurbisher 103, and/or the reclamation facility 801. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. As used herein and in the appended claims, the terms “comprises,” “comprising” or any other variation thereof is intended to refer to a non-exclusive inclusion, such that a process, method, apparatus, or article of manufacture that comprises a list of elements does not include only those elements in the list, but may include other elements not expressly listed or inherent to such process, method, apparatus, or article of manufacture. All terms used in the appended claims that are not otherwise specifically defined herein should be accorded their ordinary meanings.

We claim:

1. A method for an article manufacturer to recycle used items forming at least part of an article, the method comprising:
receiving a used item from a service center pursuant to a contractual arrangement with the article manufacturer; and
providing the used item to a reclamation facility in exchange for consideration, the reclamation facility facilitating separation of reusable elements from the used item.

2. The method of claim 1, further comprising:
after receiving the used item, providing second consideration to the service center.

3. The method of claim 2, wherein the used item is an item still under warranty and wherein the second consideration includes payment for parts and labor associated with replacing the used item with a replacement item.

4. The method of claim 3, wherein the contractual arrangement conditions payment for parts and labor associated with replacing the used item on receipt of the used item from the service center.

5. The method of claim 1, wherein the used item is an automotive component.

6. The method of claim 5, wherein the service center is one of an independent automotive repair facility and an automotive dealership.

7. A method for recycling used items, the method comprising:
receiving a used item from a manufacturer, the manufacturer having acquired the used item from a service center pursuant to a contractual arrangement between the manufacturer and the service center;
providing consideration to the manufacturer in exchange for the used item;
separating reusable elements from the used item; and
distributing the reusable elements.

8. The method of claim 7, wherein the used item is an item still under a warranty offered by the manufacturer.

9. The method of claim 7, wherein the used item is an automotive component.

10. The method of claim 7, wherein the manufacturer is a manufacturer of the used item or an article from which the used item was removed.

11. The method of claim 7, wherein the reusable elements comprise metals forming part of the used item.

12. The method of claim 11, wherein the metals forming part of the used item comprise platinum group metals.

13. A method for recycling used items, the method comprising:
receiving a used item from a service center, the used item forming at least part of an article;
providing consideration to at least a manufacturer of the article in exchange for the used item;
separating reusable elements from the used item; and
distributing the reusable elements.

14. A method for recycling used items, the method comprising:
providing a used item to a reclamation facility, the used item forming at least part of an article, the reclamation facility facilitating separation of reusable elements from the used item;
notifying a manufacturer of the article that the used item was provided to the reclamation facility; and
receiving consideration from the manufacturer at least partially in exchange for delivery of the used item to the reclamation facility and providing notice thereof to the manufacturer.

15. The method of claim 14, wherein the used item is an item covered by a warranty issued by the manufacturer and wherein the consideration received from the manufacturer includes payment for parts and labor associated with replacing the used item with a replacement item.

16. The method of claim 14, wherein the article is an automobile and wherein the used item is an automotive component.

17. A method for a manufacturer to receive revenue resulting from recycling of used items, the method comprising:
receiving notification from a service center indicating that the service center provided at least one used item to a reclamation facility, the used item forming at least part of an article distributed by the manufacturer, the reclamation facility facilitating separation of reusable elements from the used item; and
receiving consideration from the reclamation facility at least partially in exchange for receipt of the used item from the service center.

18. The method of claim 17, further comprising:
after receiving the notification, providing second consideration to the service center.

19. A method for recycling used items, the method comprising:
receiving a used item from a service center, the used item having been removed from an article by the service center;
providing consideration to a manufacturer of the article pursuant to a contractual arrangement with the manufacturer; and
selling the used item to a reclamation facility, the reclamation facility facilitating separation of reusable elements from the used item.

20. A method for recycling used items, the method comprising:
removing, by a service center, a used item from an article during servicing of the article;
providing, by the service center, the used item to a manufacturer of the article pursuant to a contractual arrangement;
after receiving the used item from the service center, providing, by the manufacturer, first consideration to the service center in accordance with the contractual arrangement;
providing, by the manufacturer, the used item to a reclamation facility;
providing, by the reclamation facility, second consideration to the manufacturer in exchange for the used item;
separating, by the reclamation facility, reusable elements from the used item; and
selling, by the reclamation facility, the reusable elements.

21. The method of claim 20, wherein the article is an automobile, wherein the used item is an automotive component that is still under a warranty provided by the manufacturer, wherein the service center is one of an independent automotive repair facility and an automotive dealership, and wherein the step of providing first consideration to the service center in accordance with the contractual arrangement comprises:
after receiving the used item from the service center, providing, by the manufacturer, payment to the service center for parts and labor associated with replacing the used item with a replacement item.
